(19) United States
(12) Patent Application Publication
(10) Pub. No.: US 2021/0220968 A1
(43) Pub. Date: Jul. 22, 2021

(54) APPARATUS FOR QUICK RELEASING AN OBJECT FROM A CLAMPING DEVICE AND METHOD FOR USING THE SAME

(71) Applicant: Breaking Bondage, LLC., Albuquerque, NM (US)

(72) Inventors: Adele Parker, Albuquerque, NM (US); Lynn Reule, Albuquerque, NM (US); David Sun, Placentia, CA (US)

(21) Appl. No.: 16/744,867

(22) Filed: Jan. 16, 2020

(51) Int. Cl. B25B 5/16; B25B 5/04

(52) U.S. Cl. CPC B25B 5/16; B25B 5/04

(57) ABSTRACT

An improved clamping device which includes at least one tether insert allowing additional objects or items to be coupled to the clamping device without having to change the physical location of the clamping device itself. The tether insert is selectively coupled to the clamping device and may be quickly detached by pulling the tether insert away from the clamping device. The clamping device also includes a magnet to assist the tether insert in obtaining a proper seat when brought into close proximity to a handle of the clamping device. The tether insert also comprises a bridge which interacts with a tether, either by wrapping or tying the tether to the bridge, or by coupling a clip or other coupling means disposed on the tether to the bridge. The removal of the tether insert does not require the actuation of the clamping device or the object it is being applied to.

### BACKGROUND

### Field of the Technology

The invention relates to the field of clamping devices, specifically a clamping device which provides for the additional coupling of an additional object which may be quickly released without having to release the clamping means itself.

### Description of the Prior Art

Clamps and clamping devices have long been used to selectively join two objects together, hold an object in place, or to tether an object which may move around within a defined radius relative to a selected stationary object. Clamps and clamping devices have been used in almost an unlimited number of circumstances such as when camping, in automotive work, and in medical procedures to namely only a select few examples. Most clamps comprise a pair of handles disposed through a single rotation or pivot point so that as the handles are squeezed together, a corresponding pair of jaws disposed on the ends of each handle are moved so as to open the clamp.

The rotation or pivot point of many clamps also comprise a self-actuating means for closing the jaws of the clamp and maintaining the clamp in a closed position when the clamp is not being used. Most commonly, the self-actuating means comprise a spring which is compressed when the handles are squeezed together by the user to open the jaws of the clamp. After the jaws of the clamp are disposed on or about the object or objects which are to be joined together, the user releases the handles which allows the spring to expand and push the jaws of the clamp back together with one of the jaws disposed on either side of the objects, thereby keeping the objects firmly together and the clamp in a stationary position relative to the objects. Other clamps may use a threaded bolt and a wing nut or another type of screw adjusting means which allows the user to manually open and close the jaws of the clamp as needed.

A problem develops however when the user wishes to join together another object when the clamp is already being employed. For example, if a traditional clamp is being used to hold two objects together or to tether a moving object such as a pet to a stationary object, and the user desires to tether an additional object using the same clamp, the user must first disengage the clamp by opening its jaws and then insert the new object or a tether attached to the new object into the clamp's opening and then letting the handles go which once again reengages the jaws through the expansion of the clamp's spring. By disengaging the clamp however, the user risks that the objects originally held together by the clamp fall apart, escape, or otherwise become loose, thereby requiring the user to readjust the positioning of the objects so that the clamp may be properly engaged with the newly added item. In other words, once a clamp is being used to join two or more objects together, it can be difficult if not impossible to add further objects to the clamp without having to first disengage the clamp and then reapply the clamp once all of the objects are properly positioned by the user. This can be a frustrating and time consuming process for the user, particularly when one or more of the objects may be in motion.

What is needed therefore is a clamping device which allows a user to add a tethered object to the clamping device without having to disengage the jaws of the clamping device. The clamping device should be easy to use and should comprise quick-release means for quickly disengaging the tethered object from the clamping device.

### BRIEF SUMMARY

The invention provides an apparatus which includes a plurality of handles, the plurality of handles themselves forming a corresponding pair of jaws at their respective distal ends. The apparatus also includes at least one tether insert that is removably coupled to at least one of the plurality of handles, wherein the at least one tether insert is configured to be coupled and uncoupled from the at least one handle without actuation of the pair of jaws.

In one particular embodiment, the at least one tether insert includes a body, a bridge disposed over the body, and a gap defined between the body and the bridge. Here, the bridge is specifically configured to be coupled to at least one tether.

In another embodiment, the apparatus also includes a magnet that is disposed on each of the plurality of handles and a corresponding plate which is in turn disposed on a bottom surface of the at least one tether insert. Specifically, the magnet is disposed on a bottom surface of an aperture which is defined within each of the plurality of handles.

In yet another embodiment, at least one of the plurality of handles of the apparatus include an aperture defined therein which is configured to accommodate the at least one tether insert so that a bridge of the at least one tether insert is flush with a surface of at least one of the plurality of handles.

In another embodiment, the apparatus further includes a means for selectively disengaging the at least one tether insert from at least one of the plurality of handles.

The invention also provides a system for coupling two objects together. The system includes a clamping device comprising a pair of jaws, at least one removable tether insert coupled to the clamping device, and a tether removably coupled to the at least one tether insert. The system also includes a means for connecting and disconnecting the at least one tether insert to and from the clamping device without having to actuate the pair of jaws of the clamping device.

In one embodiment, the at least one tether insert is specifically disposed within an aperture that is defined within a handle of the clamping device.

In another embodiment, the means for coupling the at least one tether insert to and from the clamping device without having to actuate the pair of jaws of the clamping device specifically includes a magnet that is disposed on the clamping device and a plate that is disposed on the at least one tether insert.

In yet another embodiment, the at least one tether insert form a continuous surface with the clamping device when it is coupled to the clamping device.

In a further embodiment, the clamping device specifically includes a plurality of handles coupled together through a central hub.

In another embodiment, the at least one tether insert includes a bridge, the tether further providing a means for coupling to the bridge.

Finally, the current invention provides a method for tethering an object to a clamping device. The method includes coupling the clamping device to a first object, removably tethering a second object to the clamping device, and decoupling the second object from the clamping device. In particular, the decoupling of the second object from the clamping device is carried out independently from the coupling of the clamping device to the first object.

In one embodiment, the method step of removably tethering the second object to the clamping device includes inserting a tether insert into an aperture defined within the clamping device and then seating a plate disposed on a bottom of the tether insert with a magnet disposed in the aperture.

In another embodiment, decoupling the second object from the clamping device is accomplished by decoupling a tether insert coupled to the second object from the clamping device.

In yet another embodiment, removably tethering the second object to the clamping device includes coupling a tether which is already coupled to the second object to a tether insert that is removably coupled to the clamping device.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1A is a frontal planar view of the clamping device of the current invention including a plurality of tether inserts coupled to the clamping device.

FIG. 1B is a side planar view of the clamping device seen in FIG. 1A.

FIG. 2A is a frontal planar view of the clamping device seen in FIG. 1A after one of the tether inserts has been removed from the clamping device.

FIG. 2B is a side planar view of the clamping device seen in FIG. 2A.

FIG. 3A is a magnified side view of the tether insert after being decoupled from the clamping device seen in FIG. 1A.

FIG. 3B is a bottom perspective view of the tether insert seen in FIG. 3A.

FIG. 3C is a top down view of the tether insert seen in FIG. 3A.

FIG. 4A is a frontal planar view of the clamping device seen in FIG. 1A after the clamping device is applied to an object and after a tether has been coupled to the tether insert.

FIG. 4B is a frontal planar view of the clamping device seen in FIG. 4A as a user actuates a plurality of tabs to disengage the tether insert.

FIG. 4C is a frontal planer view of the clamping device seen in FIG. 4B after the tether insert has been uncoupled from the clamping device.

FIG. 5 is a partially exploded view of the clamping device seen in FIG. 1A showing how one of the tether inserts interacts with a handle of the clamping device.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

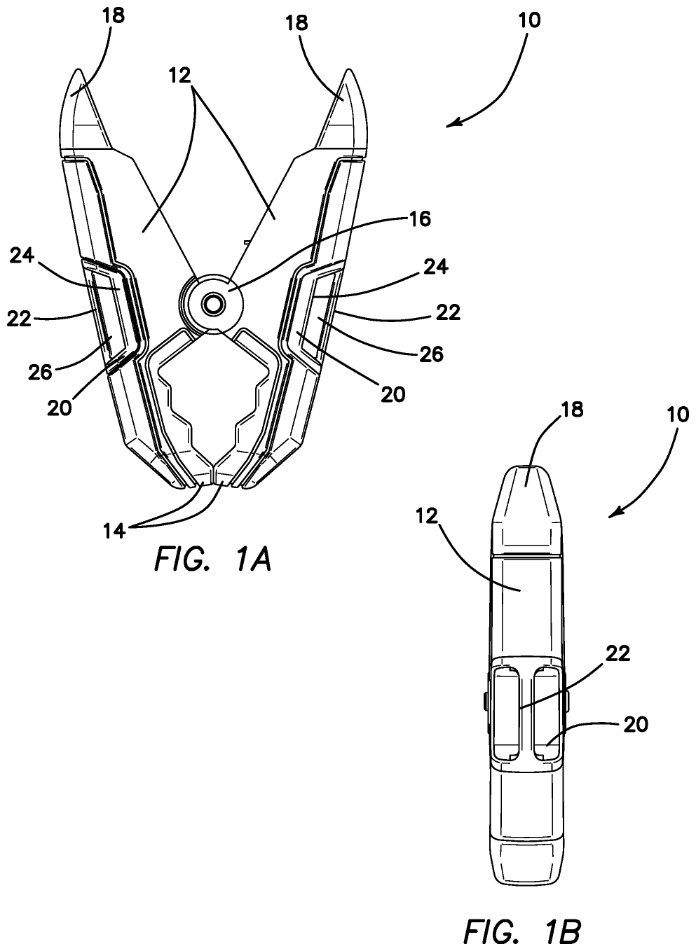

The current invention provides an improved clamping device which is seen in FIGS. 1A and 1B and which is denoted generally by reference numeral 10. The clamping device 10 comprises a pair of handles 12 with a LED 18 disposed within their respective proximal ends while their corresponding distal ends are formed into a pair of jaws 14. The handles 12 are coupled together through a centrally disposed hub 16. The hub 16 comprises an internal spring as is known in the art which is compressed every time the handles 12 are squeezed or brought together which in turn moves the jaws 14 further apart. Conversely, when pressure on the handles 12 is relaxed, the internal spring within the hub 16 expands which brings or pushes the jaws 14 back into contact within one another. The proximal ends of each of the handles 12 are transparent or semi-transparent so that light emitted from the LED 18 may shine there through and illuminate the surrounding environment. Each LED 18 may be activated via actuation of a button or switch as is known in the art, or alternatively, may be turned on through contact by the user.

Removably coupled to at least one of the handles 12 is a tether insert 20. The tether insert 20 comprises a body 24 which is specifically sized and shaped so as to form a continuous or even surface with the main portion of the handle 12 when coupled thereto as seen in FIGS. 1A and 1B. Specifically, the body 24 of the tether insert 20 comprises a shape which matches the shape and contours of each handle 12 so as to be flush or substantially flush with the surfaces of the handle 12 itself when the tether insert 20 is inserted or disposed therein. The tether insert 20 further comprises a bridge 22 disposed over the body 24. The bridge 22 is integrally coupled or formed with either side or edge 36 of the body 24 so as to define a gap 26 between the bridge 22 itself and a top surface of the body 24 of the tether insert 20.

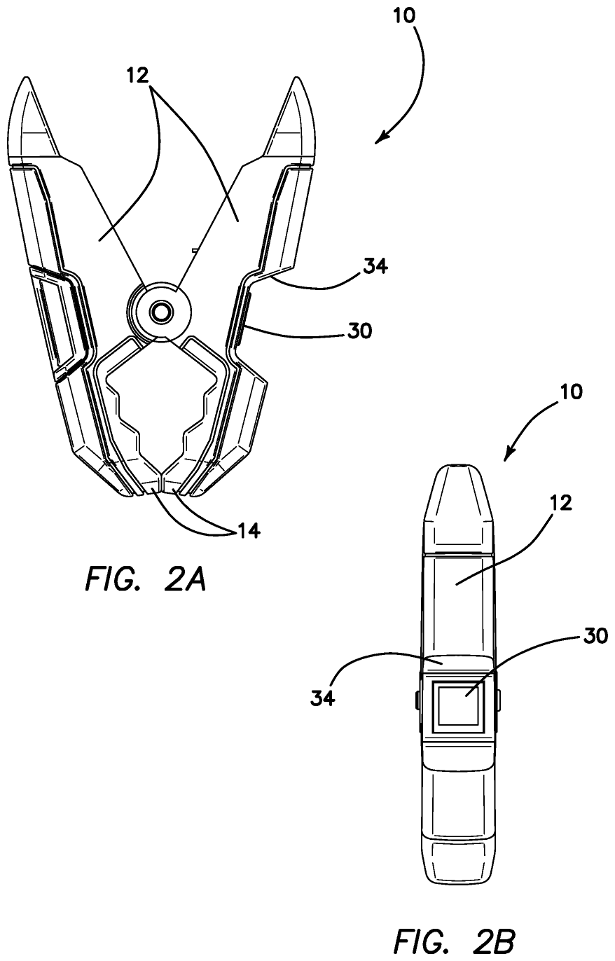

As seen in FIGS. 2A and 2B, the clamping device 10 may be seen after a tether insert 20 has been removed or uncoupled from one of the handles 12. With the tether insert 20 removed, a concave aperture 34 is revealed within each handle 12. Disposed within a bottom portion of the aperture 34 is a magnet 30.

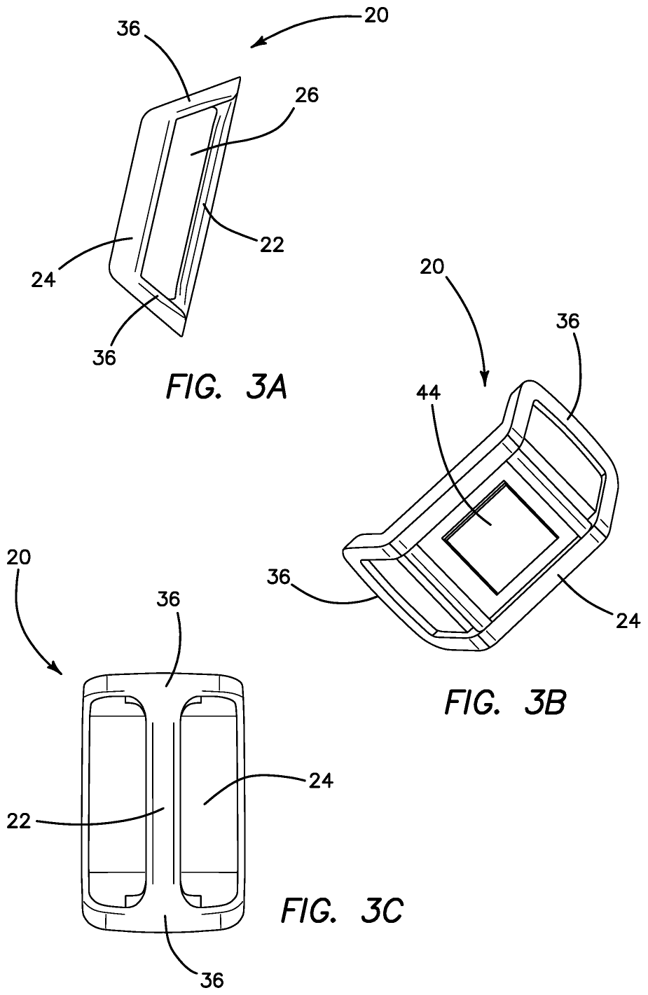

Greater detail of the each tether insert 20 may be had from FIGS. 3A-3C. In addition to a body 24 and a bridge 22, the at least one tether insert 20 further comprises a pair of angled edges or sides 36 which extend upward at an angle relative to the body 24. Either lateral end of the bridge 22 is further coupled or integrally formed with each angled side 36, thereby defining the gap 26. The gap 26 represents a volume of negative space which may accommodate a carabiner, rope, elastic cord, strap, or other object or material to be disposed there through and either wrapped or tied to the bridge 22. On a bottom surface of the tether insert 20 seen in FIG. 3B, a metal plate 44 is disposed in a substantially central position relative to the body 24. The metal plate 44 is specifically configured to match the size and shape of the magnet 30 disposed within the aperture 34 of each handle 12. Additionally, the metal plate 44 is comprised of a ferromagnetic material such as a nickel or another permalloy so that the magnet 30 and metal plate 44 are drawn together when in close proximity to each other.

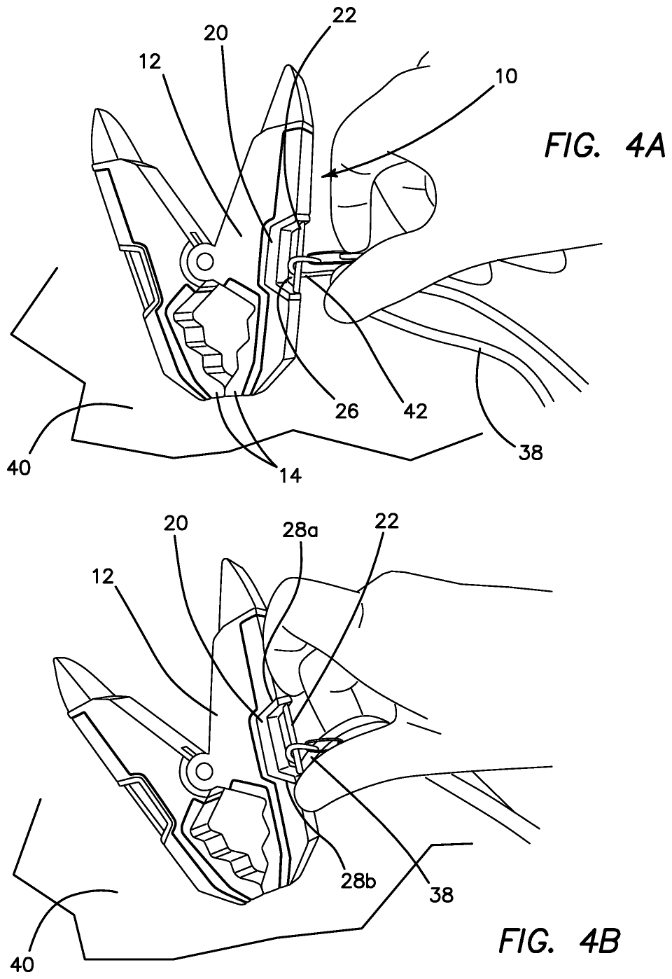

To use the clamping device 10, the user first applies the clamping device 10 to an object or a plurality of objects by squeezing the handles 12 together and separating the jaws 14 of the clamping device 10. The now open jaws 14 are disposed over or around the object(s) which the clamping device 10 is to be coupled to and the pressure applied to the handles 12 is relaxed, thereby permitting the spring in the hub 16 to expand and push the jaws 14 of the clamping device 10 together and enclose the selected object(s). In FIGS. 4A-4C, the clamping device 10 is seen as being coupled to a blanket 40, however this is meant to be for illustrative purposes only. The object which the clamping device 10 is applied to can be any type of natural or man-made item or object including but not limited to a piece of furniture, a mattress, a car seat, a tree branch, a tent peg, a post, or anything else which is capable of fitting within the jaws 14 of the clamping device 10. Once the clamping device 10 is secured to the object of choice, the user couples a tether 38 or other item as seen in FIG. 4A to the clamping device 10 by specifically coupling the tether 38 to the tether insert 20. The user may couple the tether 38 directly to the tether insert 20 by threading the tether 38 through the gap 26 and then wrapping and/or tying the tether 38 to the bridge 22. Alternatively, as seen in FIG. 4A, a carabiner, hook, or clip 42 disposed on the distal end of the tether 38 may be used to couple to the bridge 22, thereby avoiding the need to thread or dispose any other part of the tether 38 through the gap 26 of the tether insert 20. It should also be noted that the user may couple the tether 38 to the clamping device 10 before the clamping device 10 is itself coupled to the object of the user's choice, or that the user may couple multiple tethers 38 to the same tether insert 20.

With the tether 38 firmly coupled to the clamping device 10, the user may freely release their grip on the tether 38 and allow the clamping device 10 to function as intended, namely by maintaining a stationary position relative to the object(s) within its jaws 14 while the tether 38 and whatever object or item is coupled to the opposing end of the tether 38 remains within a radius relative to the clamping device 10 as determined by the length of the tether 38 itself. For example, if the user wishes to tether their dog to the clamping device 10, the user begins by coupling the clamping device 10 to any stationary object which may be in their vicinity such as a table leg or the like. The user may, after attaching the opposing end of the tether 38 which in this case may be a standard leash or other suitable means to the dog or other item, couple the tether 38 to the tether insert 20 portion of the clamping device in the manner discussed above. The user may then walk away from the clamping device 10 while leaving their dog or other item to freely move about the clamping device 10 to the extent that the leash or tether 38 permits without fear that the tether insert 20 may inadvertently detach from the clamping device 10. If the tether 38 is pulled or otherwise extended beyond its means, the clamping device 10 ensures that the tether 38 is not uncoupled or detached from it while still maintaining its grip or compressive force on the object(s) 40 disposed within the jaws 14.

To quickly release the tether 38 from the clamping device 10, the user pulls on the tether insert 20 with enough force so as to overcome the magnetic force between the magnet 30 and the plate 44 and dislodge it from the aperture 34 as seen in FIG. 4C. The tether 38 and tether insert 20 can then be removed from the vicinity of the clamping device 10 without having to uncouple or detach the jaws 14 of the clamping device 10 from the object 40 it is originally attached to. If the user wishes to reattach the tether 38 to the clamping device 10, the tether insert 20 is once again placed into the aperture 34 defined in the handle 12 so that the plate 44 of the body 24 is substantially disposed over the magnet 30 disposed in the handle 12. The magnet 30 attracts the plate 44 so as to assist with properly seating the tether insert 20 within the aperture 34 where the user may push the tether insert 38 into the handle 12, thereby once again engaging the tether insert 20 and locking it into place. In the manner discussed above therefore, the use may selectively attach and detach the tether insert 20 and item coupled thereto as desired without having to adjust the engaging means of the clamping device 10 at all. If the user wishes to couple the tether 38 to a non-removable portion of the clamping device 10, the user may instead couple or tie the tether 38 to a second bridge disposed within the opposing handle 12 of the clamping device 10, namely the handle 12 which does not accommodate the at least one tether insert 20.

In one particular embodiment, the clamping device 10 may be specifically used for adult entertainment purposes or as a sexual aide for adults. For example, the clamping device 10 may be applied to a first object such as a pillow or headboard by squeezing the handles 12 and disposing the open jaws 14 over the object. Once secured, a tether 38 may be coupled to the clamping device 10 as discussed above with the opposing end of the tether 38 forming a loop or ring for going over a user's wrist or ankle. The user is then attached or restrained to the object on which the clamping device 10 is disposed. To decouple the tether 38 from the clamping device 10 at any point, the user simply moves their arm or leg with enough force so as to disengage the tether insert 20 from the magnetic plate 30, thereby freeing themselves from the stationary position of the clamping device 10. The clamping device 10 therefore provides an easy to use means to hold a person to a stationary object which does not require constant readjustment by the user or their partner and which further allows the user to instantly and safely free themselves the moment they no longer desire to be coupled to the object.

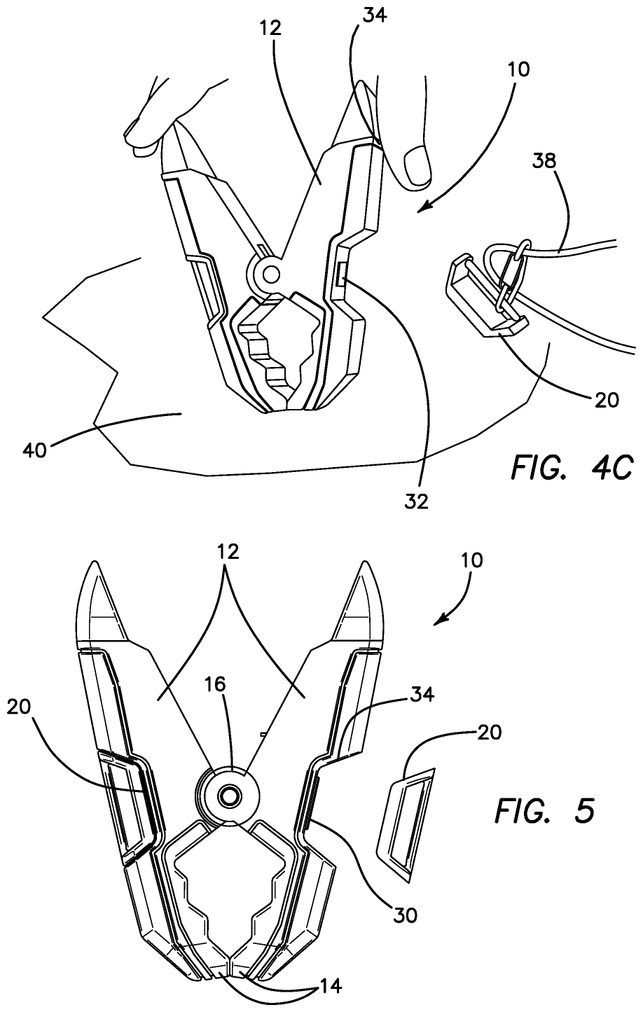

As seen in the partially exploded view of FIG. 5, at least one handle 12 comprises a removable tether insert 20 coupled thereto thereby providing the user the ability to attach up to two additional items to the clamping device 10 without having to first disengage the clamping device 10 from the object 40 it is currently applied to.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. An apparatus comprising:
a plurality of handles, the plurality of handles forming a corresponding pair of jaws at their respective distal ends; and
at least one tether insert removably coupled to at least one of the plurality of handles,
wherein the at least one tether insert is configured to be coupled and uncoupled from the at least one handle without actuation of the pair of jaws.

2. The apparatus of claim 1 wherein the at least one tether insert comprises:
a body;
a bridge disposed over the body; and
a gap defined between the body and the bridge.

3. The apparatus of claim 2 where the bridge is configured to be coupled to at least one tether.

4. The apparatus claim 1 further comprising:
a magnet disposed on each of the plurality of handles; and
a plate disposed on a bottom surface of the at least one tether insert.

5. The apparatus of claim 4 wherein the magnet is disposed on a bottom surface of an aperture defined within each of the plurality of handles.

6. The apparatus of claim 1 wherein each of the plurality of handles comprise an aperture defined therein which is configured to accommodate the at least one tether insert so that a bridge of the at least one tether insert is flush with a surface of at least one of the plurality of handles.

7. The apparatus of claim 1 further comprising means for selectively disengaging the at least one tether insert from at least one of the plurality of handles.

8. The apparatus of claim 7 wherein each of the plurality of handles comprise an LED disposed in their respective proximal ends.

9. A system for coupling two objects together comprising:
a clamping device comprising a pair of jaws;
at least one tether insert coupled to the clamping device;
a tether removably coupled to the at least one tether insert; and
means for coupling the at least one tether insert to and from the clamping device without actuating the pair of jaws of the clamping device.

10. The system of claim 9 wherein the at least one removable tether insert is disposed within an aperture defined within a handle of the clamping device.

11. The system of claim 9 wherein the means for coupling the at least one tether insert to and from the clamping device without actuating the pair of jaws of the clamping device comprises a magnet disposed on the clamping device and a plate disposed on the at least one tether insert.

12. The system of claim 9 further comprising an LED disposed within a proximal portion of the clamping device.

13. The system of 9 wherein the at least one tether insert forms a continuous surface with the clamping device when coupled to the clamping device.

14. The system of claim 9 wherein the clamping device comprises a plurality of handles coupled together through a central hub.

15. The system of claim 9 wherein the at least one tether insert comprises a bridge and wherein the tether comprises means for coupling to the bridge.

16. A method for tethering an object to a clamping device comprising:
coupling the clamping device to a first object;
removably tethering a second object to the clamping device; and
decoupling the second object from the clamping device,
wherein decoupling the second object from the clamping device is carried out independently from the coupling of the clamping device to the first object.

17. The method of claim 16 wherein removably tethering the second object to the clamping device comprises:
inserting a tether insert into an aperture defined within the clamping device; and
seating a plate disposed on a bottom of the tether insert with a magnet disposed in the aperture.

18. The method of claim 16 wherein decoupling the second object from the clamping device comprises decoupling a tether insert coupled to the second object from the clamping device.

19. The method of claim 16 further comprising illuminating the clamping device through an LED disposed within a proximal portion of the clamping device.

20. The method of claim 16 wherein removably tethering the second object to the clamping device comprises coupling a tether coupled to the second object to a tether insert removably coupled to the clamping device.
